(19) United States
(12) Patent Application Publication
(10) Pub. No.: US 2003/0212953 A1
(43) Pub. Date: Nov. 13, 2003

(54) Method of feeding a spreadsheet type tool with data

(75) Inventor: M. Jacob Serraf, Puteaux (FR)

Correspondence Address: WEINGARTEN, SCHURGIN, GAGNEBIN & LEBOVICI LLP, TEN POST OFFICE SQUARE, BOSTON, MA, 02109, US

(73) Assignee: EUROFINANCIALS.COM

(21) Appl. No.: 10/435,400

(22) Filed: May 9, 2003

(30) Foreign Application Priority Data
May 10, 2002 (FR) 02-05811

(51) Int. Cl. G06F 17/00

(52) U.S. Cl. 715/503; 715/508

(57) ABSTRACT

The invention provides a method of sending data for a spreadsheet in a first data processor apparatus, the data being sent by a second data processor apparatus, said method comprising the following steps:

the second data processor apparatus receiving a request to transfer a data set as sent by the first data processor apparatus;

the second apparatus generating identification data enabling the first apparatus to identify a template for presenting said data set; and

the second apparatus sending to the first apparatus both said identification data and at least a portion of said data set.

### TECHNICAL FIELD AND PRIOR ART

The invention relates to a method of feeding data to a spreadsheet type tool, such as the tool known under the name “Excel”.

More generally, a spreadsheet is a computer application for manipulating data in a table, for calculating complex formulae acting on said data, for obtaining graphical representations thereof or representations in database form, etc.

It can be used for simple requirements (directories, calculating the average marks of school children, personal accounting, . . . ) or for developing complex applications (assistance in decision-making, . . . ).

The problem arises of feeding that type of tool or facility with external data coming from an outside environment different from that on which the tool or the facility operates. In practice, a user may have available, for example, a computer running a spreadsheet on which data can be received, with said data being produced and then delivered by a server.

At present, various known technical solutions exist on the market for implementing the above-mentioned function of feeding a spreadsheet with data.

In a first type of solution known as an “add-in”, an application additional to the spreadsheet is associated therewith and enables it to communicate with the outside. That type of solution can be used to create functions that are parameterizable and it gives a degree of flexibility to the spreadsheet.

There also exist spreadsheets operating under “Windows” technology by means of a mechanism of the “dynamic data exchange” (DDE) type.

Both of those two types of solution operate in a so-called “pull” mode as shown diagrammatically in FIG. 1.

In FIG. 1, reference 2 designates the workstation of a user (e.g. a PC type microcomputer), provided with a spreadsheet function 4 and with an “add-in” function 6 providing communication with the outside. An engine or navigator 8 is used for searching for the corresponding data.

Parameters are initially input by the user from a menu. These parameters are analyzed in order to define the data needed for calculating them, which data needs to be searched for in the server 12. This analysis leads to a request being formulated for transmitting to the platform or server 12.

The platform or server then proceeds to execute the request (i.e. to search for data in the information available to it), and then transfers the data to the user. On the user's computer, information corresponding to the initially-input parameters is computed on the basis of the data provided by the server, and is then inserted into the spreadsheet 4, and finally displayed.

Such solutions of the “lpull” type (i.e. actively searching for data), nevertheless remain tools for specialists and they suffer from certain drawbacks, and in particular the following:

Firstly, they use a mechanism that is too complex for many users, in particular concerning inputting new functions, or proprietary syntax, and also concerning any personalization.

Thereafter, the logic of those solutions is decorrelated from the platform 12 since data is exported to the spreadsheet. It is impossible to associate a facility of the server 12 with export to the spreadsheet, and vice versa.

All of those solutions are “data” oriented (and not formula oriented), and they are also poorly adapted to large volumes.

Finally, the files that are generated cannot be used unaltered because proprietary functions or links are used in a spreadsheet file thus making it necessary to have special-purpose applications modules available and to be connected to the server 12 in order for the files to be directly usable.

Another type of solution, one example of which is given on the Web site www.softartisans.com, enables a spreadsheet to be opened directly in the user's navigator or “browser”. Files are generated in Excel format in a server, and they are then transmitted to a user.

That type of product (which unlike the other two operates in “push” mode, i.e. selective delivery of data) is very time consuming to develop and requires programming in a language such a C or C++ at the server. The slightest modification thus requires further intervention in the same language. That type of product therefore likewise remains a tool for specialists.

Another drawback is that the presentation of the data is not adaptable or personalizable by the user: the format in which tables are exported is determined by the server. FIG. 2 is a diagram showing this second solution of the “push” type: by means of a navigator 28, a user 20 can view data directly on a server 22, and can select the data the user desires to receive.

A request is thus formulated, after which a file is generated in the server in the format of the spreadsheet. The format is thus determined by the server and is the same for all users. The file is then transferred (e.g. using the http protocol) by the server to the user. On receiving a file (in binary format), the user's navigator 28 invokes the spreadsheet 24 and sends it the data.

The problem arises of enabling a user to have server-manipulated data available in a spreadsheet, together with the associated application logic, and for this to take place in a format that is predefined and easily personalized by the user.

### SUMMARY OF THE INVENTION

The invention relates firstly to a method of sending data for a spreadsheet in a first data processing apparatus, the data being sent by a second data processing apparatus, the method comprising the following steps:

the second data processor apparatus receiving a request to transfer a data set as sent by the first data processor apparatus;

the second apparatus generating identification data enabling the first apparatus to identify a template for presenting said data set; and

the second apparatus sending to the first apparatus both said identification data and at least a portion of said data set.

Thus, the data presentation template can be designed and implemented directly on or in the first apparatus, without time-consuming programming on the second.

In addition, the data presentation template is easily personalized, without requiring the user of the first apparatus to have any particular expertise.

The identified template may be stored in the first apparatus. The first apparatus can also store at least two different data presentation templates, the identification data making it possible in the first apparatus to identify one of the templates.

The data in the set of data requested by the first apparatus may be generated by searching in memory means or in a database of the second data processor apparatus.

A data set for presenting in a presentation template may also be transmitted together with data identifying the data presentation template.

In a variant, after sending said identification data, the second apparatus receives a request issued by the first apparatus for transmitting at least a portion of said data set, and then proceeds with said transmission to the first apparatus.

The portion of the data transmitted is preferably sufficient for feeding or filling the spreadsheet of the first apparatus.

In this variant, only the identification data is initially sent to the user. On receiving this data, the user's apparatus generates a request for transmitting the wanted data to the selected template. This data is transmitted by the server to the user apparatus and is associated with the predefined template.

The identification data of a data presentation template may also include data describing the structure of the data requested by the user.

The first and second apparatuses may be connected together by means of a network.

The invention also provides a method of generating a data presentation template in a first data processor apparatus, the method comprising the following steps:

receiving, from a second data processor apparatus, data identifying a template for presenting a data set; and

using said identification data to search for said template in memory means of said first apparatus.

A method of feeding a spreadsheet of a first data processor apparatus with data may then comprise:

generating a data presentation template as specified above; and

associating received data with or in said template.

The data may be received together with data identifying the data presentation template.

In a variant, after generating a data presentation template, a request for data transmission is sent to the second data processor apparatus, e.g. sufficient data for feeding or filling the spreadsheet of the first apparatus.

In the first apparatus, the transferred data may optionally be subjected to defined processing in association with the selected template.

The step of associating data and the template may be implemented by the spreadsheet itself in the user station.

A method of transferring and presenting data in accordance with the invention may comprise a method of sending data as described above, together with a method of generating a data presentation template as described above.

In the invention, a user selects the data the user would like to receive from the second apparatus (e.g. a server). A request is formulated, after which a file is generated, not in the spreadsheet format imposed by the second apparatus, but including data making it possible in the user's apparatus to identify a data presentation template requested by the user, said template being already present or installed on said user's apparatus.

This file and/or its header is/are then transferred by the server to the user's apparatus, which can then associate the selected template with the requested and transmitted data, possibly separately from the identification data, or it can open the template and place the transmitted data therein.

Such a method provides much greater flexibility for the user, and does not require specific time-consuming programming of the server in an object-oriented language such as C or C++.

In addition, it makes it possible to make a wider variety of options available since it is possible to execute “postprocessing” on the user's station, after generating the table.

The invention also provides a method of feeding a spreadsheet with data, the method comprising the following steps:

structuring and formatting data on a server;

transmitting the data to the user; and

decoding the data and associating it with a predetermined format or template in the user's apparatus.

The invention also provides a device for sending data for a spreadsheet in a data processor apparatus, the device comprising:

means for receiving, or programmed to receive, a request for transferring a set of data as issued by the data processor apparatus;

a generator of or means for generating or programmed to search for identification data enabling a template for presenting said data set to be identified in the apparatus, said template being stored in the apparatus;

a search engine or means for searching or programmed to search in storage means for at least a part of said data set requested by the data processor apparatus; and

means for or programmed for sending to the apparatus both the identification data and at least a portion of said data set.

This device operates in selective data delivery mode (“push” mode).

The invention also provides a device for processing data, the device comprising:

means for storing one or more templates for presenting a data set;

means for receiving data identifying a template for presenting a data set;

means for or programmed for using said data to search for a template in the storage means of said first apparatus; and

means for or programmed for associating a data set with a template identified using said identification data.

Finally, the invention also provides a program having instructions for implementing one or more of the methods specified above, a data medium capable of being read by a computer system and carrying data in coded form for implementing one or more of the above-described methods, or indeed a software package comprising a data medium suitable for being read by a computer system, enabling one or more of the above-described methods to be implemented.

All of the data referred to herein is in digital form, with the data processor apparatuses receiving, generating, processing, and transmitting digital data.

The invention offers the following advantages in particular:

Data exported to the user is in context (it depends on the Web page visited) and easy for the user to understand since the exported data is associated directly with the data viewed at the time of export.

The solution is ergonomic since firstly it operates on a “pushbutton” basis (i.e. it is of the “push” type, in which data is delivered selectively); and secondly, when the user views the desired view on the screen of the second apparatus, it suffices for the user to click to recover the source data and the associated logic (identification data) in the user's own spreadsheet, thus enabling the results to be obtained.

Insofar as all of the data for a template is downloaded in a single request (or at worst: in two requests when the identification is transmitted separately), this solution is highly effective compared with engines or with “pull” type solutions which download information piecemeal (field by field or request by request).

The output files have no link with the server (or the second apparatus) and thus become independent of the platform. They can also be sent or used as they stand.

The server or second apparatus is lightly loaded since its role is restricted to selecting source data and to exporting it raw, with processing being independent of the user.

### BRIEF DESCRIPTION OF THE FIGURES

FIGS. 1 and 2 are diagrams showing two known techniques of the prior art.

FIGS. 3 and 4 are diagrams showing a system for implementing the present invention.

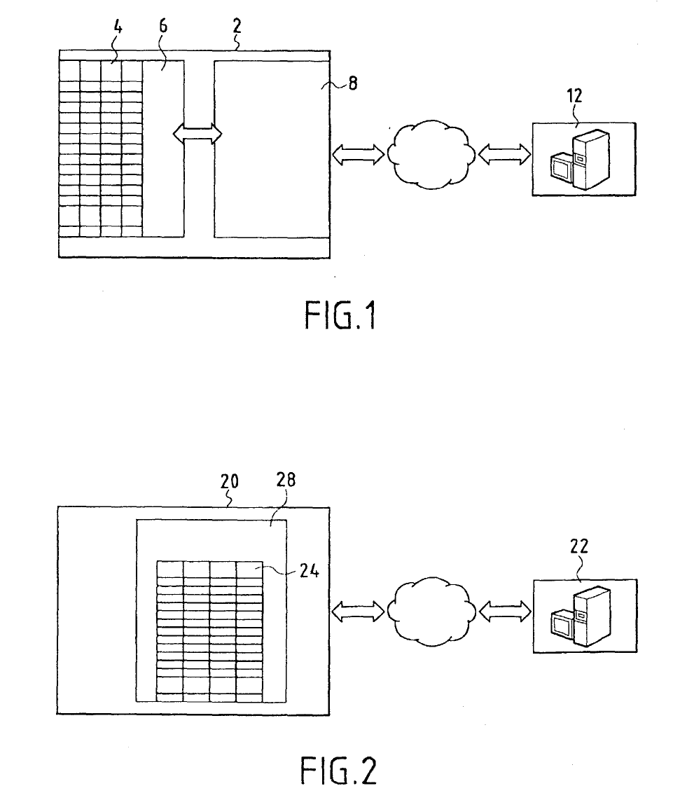

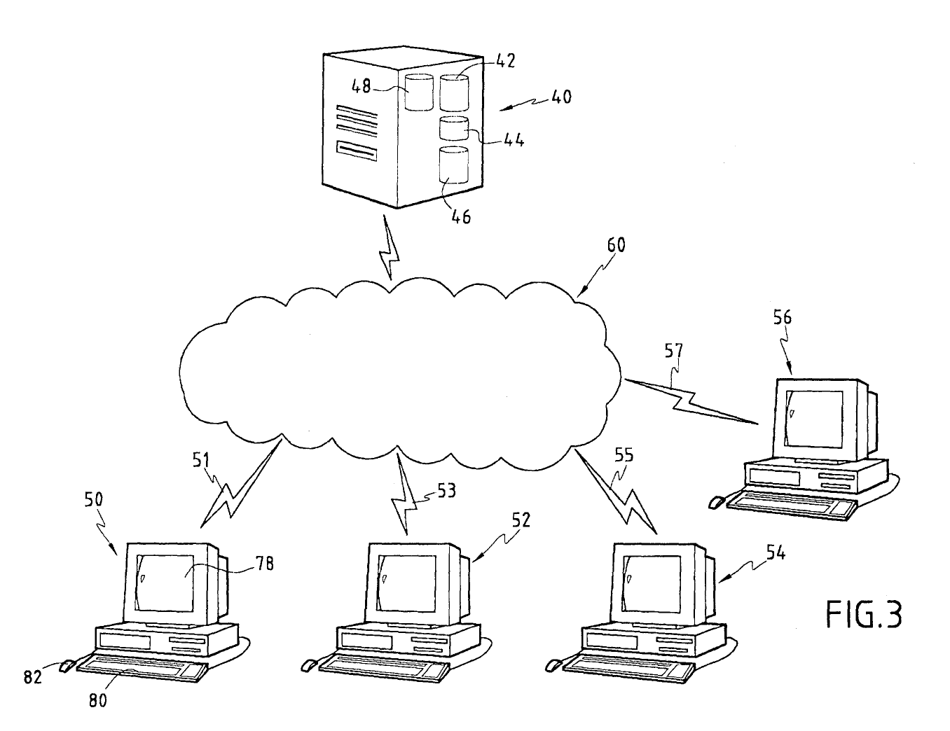

### DETAILED DESCRIPTION OF EMBODIMENTS OF THE INVENTION

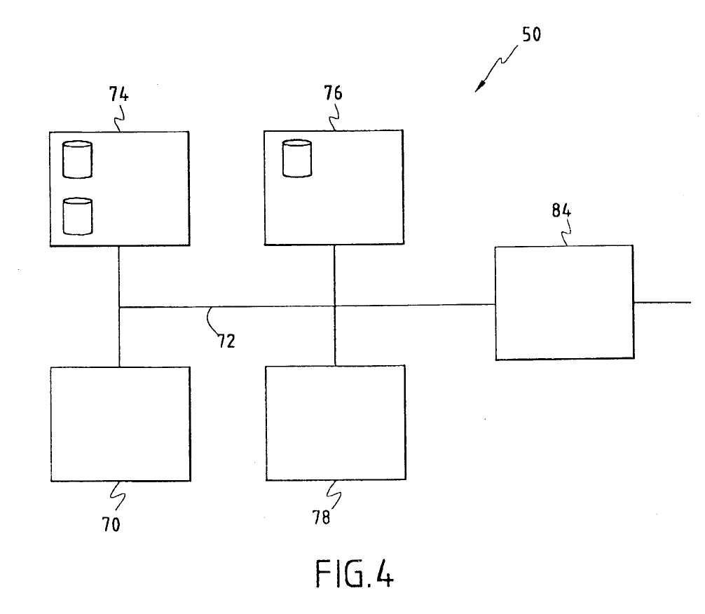

A set of means for implementing the present invention is described with reference to FIGS. 3 and 4.

In FIG. 3, reference 40 designates a computer or a server or an electronic site (the terms “server” or “platform” are used below, but it would be equally possible to use terms such as “computer” or “electronic site”) to which various users, each having a data processor apparatus, e.g. a PC type microcomputer 50, 52, 54, 56, . . . , can connect or have access via a network 60, e.g. the Internet. Each user accesses the network over an individual connection 51, 53, 55, 57, . . . and has a respective address.

The user apparatuses may also be portable terminals with connection means or communications means suitable for accessing the server 40.

In storage means 42, the server stores data, e.g. in the form of a dictionary or a database containing a set of elements. It is from this database that is desired to feed spreadsheets in the data processor apparatuses 50, 52, 54, 56 of the various users.

For each element, the dictionary may contain a description based on attributes suitable for use, for example, during subsequent processing, or merely while displaying the elements.

These examples of the database or dictionary are codified, which makes it possible to define a syntax that is common between the platform (server) and the users 50, 52, 54, and 56.

Below, as an example of such elements, reference is made to economic data relating to companies, but this example is not limiting and other applications could be concerned.

FIG. 4 is a block diagram showing the various components of a data processor apparatus 50. A microprocessor 70 is connected via a bus 72 to a set of random access memories (RAM) 74 for storing data, and to a read-only memory (ROM) 76 in which program instructions can be stored. The system also comprises a display device 78, or screen, and peripheral means 80 (keyboard) or 82 (mouse), see FIG. 3.

Reference 84 designates modem type means constituting an interface with the network. The other apparatuses 52, 54, . . . may have the same structure. Overall, the structure of the server is of the same type, having one or more processors, data storage zones (referenced in FIG. 3 as 42, 44, 46) and a connection to the network.

In general, each user apparatus has means 78 for displaying data, as transmitted by the computer 40 via the communications and/or transmission means 51, 53, 55, 57, 60.

Each user apparatus also has means 80 for entering requests in order to obtain certain data from the database. The data is transmitted to the computer or server 40 via the communications and/or transmission means 51, 53, 55, 57, 60.

Each user apparatus 50, 52, 54, 56 has a spreadsheet, i.e. a computer application as defined above.

It may also have a navigator, a program for exploring the Web, and in particular for searching and consulting documents, and for making use of the hypertext links they contain.

The two best-known navigators on the market at present are known under the names “Internet Explorer” from Microsoft and “Netscape Navigator”.

Each data processor apparatus 50, 52, 54, 56 can also be fitted with a “client engine”. This type of program can either:

be independent of the spreadsheet, in which case it is implemented in the form of a program executable by the operating system of the user apparatus (a self-contained EXE application, a system service, . . . ); or else

be in the form of an “add-in” which is integrated in the user's spreadsheet.

By way of example, this engine may be triggered automatically on receiving a file sent from the platform or server.

The template is a file in the format of the spreadsheet used in the user's apparatus.

For data that has been transferred from the server to the user's apparatus, the template serves to define the presentation desired by the user. The user can define this presentation: for example, it may be a combination of one or more tables together with one or more graphics.

For a data set received from the server, the user can define two types of file (or “sheet”):

the source data file: this contains elements of the data dictionary received from the server, optionally together with other parameters; and

the result file: this contains tables, graphics, in the presentation desired by the user, and obtained by using the source data file.

A user apparatus may contain a plurality of templates in memory, for example for use as a function of such-and-such a type of data.

The server is programmed, or data or program instructions are stored in one or more memory zones of the server, in order to implement a method of the invention, and in particular in order to respond to a request from a user by preparing and sending identification data of a template for presenting data taken from the database or the dictionary.

The database data is searched by a search engine or by means programmed to search for the data requested by the user.

The identification data is sent together with the data taken from the database, or in the same file.

In another implementation, the data identifying the template is sent initially, and the data taken from the database (and preferably only data that is suitable for the template), is sent separately on a subsequent request: the user's apparatus has then identified and is programmed to identify the data needed for the template, and it requests said data. This implementation reduces the quantity of data that needs to be transmitted.

If a plurality of templates are present in the user's apparatus, then a template can be selected, for example as follows:

by defining a default template: data identifying the default template is sent, with the user being capable of subsequently requesting another template; or else

by initially requesting the user to select a template, for example by opening a window giving several possible choices to the user.

A user's data processor apparatus is programmed, or program instructions or data are stored in a memory zone of a data processor apparatus of at least one user, in order to implement a method of the invention, and in particular to introduce a request for sending certain data, to be capable of receiving in return data identifying a data presentation template, and to search in the memory means of the processor apparatus for a data presentation template as identified by said data identifying a presentation template.

In each case, the program instructions or data can be transferred into a memory zone of the server 40 or of the user's apparatus from a floppy disk or any other medium (e.g.: hard disk, ROM, dynamic RAM (DRAM), or any other type of RAM, compact optical disk (CD), magnetic or optical storage element) capable of being read by a microcomputer or a computer or a data processor apparatus.

The data requested by a user from an apparatus 50, 52, 54, 56 can be transferred from the server by view (with a view name or a generic name associated with the server's screen), and when the data is economic data relating to companies, by company or by group of companies (each identified by its name or by a company group identified by a group name or indeed by country). This transfer may also be performed by year(s) or by price history.

In an embodiment of the invention, the file sent by the server has a header and the data, the data being taken from the server's database and being the data the user wishes to receive.

The header serves to specify the information that is to be used for processing the file, and in particular information or identification data serving to identify a template for presenting the data taken from the server's database.

The destination apparatus (and in particular its engine) receives the file sent by the platform, performs the appropriate formatting as a function of the presentation template (as identified by the identification data), and then forwards the result to the spreadsheet, either directly if it is implemented in the template of an add-in for the spreadsheet, or else via a mechanism of the DDE or OLE-Automation type, if it is implemented as an independent method.

More generally, the destination apparatus has means for formatting data and for transmitting the formatted data to the spreadsheet.

At the request of the user, the server generates a structured data file which is transmitted (pushed) to the navigator of the user's apparatus or workstation.

At system or navigator level, the extension of the file name is associated with the engine application.

On receiving the data file, the navigator and/or the system invokes the engine which, in a detailed example, then performs the following processing:

1) analyzing the header of the transmitted data;

2) decoding and structuring the data;

3) searching locally for the template, e.g. in the memory means or the hard disk of the user's apparatus;

4) opening the template in the spreadsheet (directly if the engine is an add-in, or via OLE-Automation or DDE if the engine is external);

5) analyzing the structure of the template to determine which data it needs (a template may need only a subset of the data supplied by the server);

6) duplicating the template (the original template is not modified);

7) dynamically associating data in the template (directly for an “add-in” or via OLE-Automation or DDE for an external engine); and

8) optionally performing post-processing (in the spreadsheet).

In a variant of step 3, it is also possible to search for the template remotely on the server and then import it into the user's computer: this applies for example when a new version of the template becomes available. This variant is particularly advantageous when a plurality of users are using the same template, for example a plurality of users in a given company or a plurality of users in a given group of companies.

In another embodiment, the server sends only the header. This is analyzed and a template is identified. After the template has been opened, the user apparatus generates a request with the server (a synchronous request) and recovers only that part of the data which is of use to the template, thus making it possible to optimize the volume of data that is transferred.

Specific processing may optionally be performed (post-processing). Such post-processing constitutes a set of operations that can be added to the end of each export operation performed by the engine. By way of example, this processing can be defined in the data file identifying the template.

In the invention, each user in a group of two or more users can identify a personal data template T1 different from the template T2 of at least one other user in the same group. The same data from the database or from the user memory can then be called by different users and presented using the different templates of those users.

The same user can also have a plurality of templates T1, T2, . . . available in memory, with one of these templates being identified by the identification data transmitted by the server. The user can configure the tool either for a (modifiable) default template, or by means of a window offering a selection of different templates.

What is claimed is:

1/ A method of sending data for a spreadsheet in a first data processor apparatus, the data being sent by a second data processor apparatus, said method comprising the following steps:
the second data processor apparatus receiving a request to transfer a data set as sent by the first data processor apparatus;
the second apparatus generating identification data enabling the identification, in the first apparatus, of a template for presenting said data set; and
the second apparatus sending to the first apparatus both said identification data and at least a portion of said data set.

2/ A method according to claim 1, said data set being transmitted with said identification data.

3/ A method according to claim 1, comprising sending said identification data initially, and then:
the second apparatus receiving a request for transmission of at least a portion of said data set, sufficient for the presentation template identified in the first apparatus; and then
sending said portion of the data to said first apparatus.

4/ A method according to claim 1, said template being previously stored in the first apparatus.

5/ A method according to claim 1, said template not being previously stored in the first apparatus, and being transmitted thereto on request therefrom after receiving the identification data.

6/ A method according to claim 1, in which the first and second apparatuses are interconnected by a network.

7/ A method according to claim 1, in which data defining data processing to be performed in said first apparatus is sent together with said identification data.

8/ A method of generating a template for presenting data in a first data processor apparatus, the method comprising the following steps:
receiving, from a second data processor apparatus, data identifying a template for presenting a data set; and
using said identification data to search for said template in memory means of said first apparatus.

9/ A method according to claim 8, including the step of the first apparatus sending to the second apparatus a request to send the data corresponding to said template, if said template is not contained in the memory means of said first apparatus.

10/ A method of feeding data to a spreadsheet in a first data processor apparatus, the method comprising:
generating a data presentation template in accordance with claim 8; and
associating a received data set with or in said template.

11/ A method according to claim 10, in which the data set is received together with the data identifying the data presentation template.

12/ A method according to claim 10, including, after a data presentation template has been generated, sending to the second data processor apparatus a request for transmission of said data set.

13/ A method according to claim 12, in which said data set is sufficient for feeding or filling a spreadsheet of the first apparatus.

14/ A method according to claim 8, the first apparatus further comprising an engine or means for formatting said data set.

15/ A method according to claim 14, the first apparatus further comprising a spreadsheet, the engine or the means for formatting data serving to transmit said formatted data set to the spreadsheet.

16/ A device for generating and sending data for a spreadsheet in a data processor apparatus, the device comprising:
means for receiving a request to transfer a data set as sent by the data processor apparatus;
means for generating identification data enabling the apparatus to identify a template for presenting said data set, said template being stored in said apparatus;
means for searching in storage means for at least a portion of said data set requested by the data processor apparatus; and
means for sending to the data processor apparatus both the identification data and at least a portion of said data set.

17/ A device according to claim 16, further comprising means for receiving, after the identification data has been sent, a request for transmitting at least a portion of said data set.

18/ A computer system including a device according to claim 16, together with a data processor apparatus.

19/ A system according to claim 18, the data processor apparatus comprising:
storage means for storing one or more templates for presenting a data set;
receiver means for receiving data identifying a template for presenting a data set;
search means for using said identification data to search for said template in the storage means of said apparatus; and
association means for associating a data set with a template identified by said identification data.

20/ A data processor device comprising:
storage means for storing one or more templates for presenting a data set;
receiver means for receiving data identifying a template for presenting a data set;
search means for using said data to search for a template in the storage means of said apparatus; and
association means for associating a data set with a template identified by said identification data.

21/ A computer program including instructions for implementing a method according to claim 1.

22/ A computer medium suitable for being read by a computer system, containing data in code form for implementing a method according to claim 1.

23/ A software package including a data medium suitable for being read by a computer system, the package enabling a method according to claim 1 to be implemented.
